(19) United States
(12) Patent Application Publication
(10) Pub. No.: US 2013/0137793 A1
(43) Pub. Date: May 30, 2013

(54) Construction Coating Compositions And Methods Of Applying The Same

(71) Applicants: John Garuti, JR., New York, NY (US); Louis M. Calvo, Bayshore, NY (US)

(72) Inventors: John Garuti, JR., New York, NY (US); Louis M. Calvo, Bayshore, NY (US)

(73) Assignee: Formulated Solutions LLC, Woodside, NY (US)

(21) Appl. No.: 13/304,773

(22) Filed: Nov. 28, 2011

(51) Int. Cl. C08K 3/00; B23P 25/00; B05D 7/24; B05D 3/00; B05D 3/10

(52) U.S. Cl. 523/122; 524/2; 427/299; 427/302; 29/458

(57) ABSTRACT

A composition for use in construction comprising pigment, dry cement and at least 30% powder polymer is provided. The composition has enhanced color retention and abrasion resistance and when applied to a surface the composition produces a smooth or textured, water-shedding properties that are aesthetically-pleasing. The coated surface as well as the method of preparing and applying the composition is also provided.

### FIELD OF THE INVENTION

The invention relates to an efflorescence resistant construction-coating compositions for producing smooth and textured, substantially continuous protective surfaces as well as methods of coating a surface with the same. In particular, the present invention relates to a dry composition that when hydrated produces a finishing coating composition substantially free of volatile organic compounds (VOC) that when applied to a surface produces a smooth, abrasive resistant, efflorescence resistant, water-shedding (hydrophobic), aesthetically-pleasing, protective continuous coating with state-of-the-art anti-microbial protection.

### BACKGROUND OF THE INVENTION

Builders of both commercial and noncommercial buildings are constantly looking for new innovative products in order to make buildings more energy efficient, to better protect them from the weather as well as make the buildings more aesthetically pleasing.

Energy efficiency is directly related to thermal insulation. That is, the less energy lost to the surrounding environment by the building structure, the less energy required to heat the building. A well-insulated building leads to increased energy savings. As for weatherproofing, products that increase water shedding (hydrophobicity) enhance the weatherproofing of the building. However, numerous products on the market today that have improved thermal insulation as well as enhanced water shedding are not as aesthetically pleasing as less efficient products that are designed for this purpose. One product currently in use today in the building industry is stucco. Although stucco has some good qualities, it suffers from a number of very serious shortcomings including lack of efflorescence resistance over time.

Colored stucco, made up almost exclusively of sand and cement, loses color over time. One way that this problem can be combated, is to apply color-preserving agents to the outer surface of the stucco finish. However, the color preserving agents available on the market today are formulated as liquids and contain volatile organic compounds (VOC) that are not only harmful for the environment but create numerous health risks for workers applying these sealants. In addition, these preservatives contain numerous organic materials that require the color preserving agent to be shipped in liquid form instead of in a ready mix dry form, which drastically adds to the shipping costs associated with these products. Moreover, color-preserving agents have strict storing and shipping requirements, present additional hazards when shipped, and have a limited shelf life due to possible chemical separation/break down of these liquid sealants. Most important they do not work over a long period of tome since they are surface coatings and either wears off, stripped off by weather conditions and/or simply are only on the surface and does not protect the color throughout the mixture. Thus even treated Stucco products suffer from the lack of color retention and poor abrasion properties.

Therefore, what is needed is a dehydrated composition that upon hydration can be applied to a porous surface in order to sufficiently fill in the pores, cracks, and crevices of the surface to be coated so as to create a water shedding (hydrophobic) finish having a strengthened, smooth esthetically pleasing surface that retains color when exposed to weather conditions over time. The present disclosure provides such a composition as well as a method for applying the composition to a prepared surface. The composition and methods of the present disclosure are further discussed and described in the sections that directly follow.

### SUMMARY OF THE INVENTION

The present invention is directed to a composition for use in construction that when applied to a prepared surface such as concrete, stucco, EIFS Base Coat and fiber-reinforced cement backer board, to name a few, seals, strengthens and provides an esthetically pleasing, water-shedding, smooth or textured continuous coatings that has increased color retentions and better abrasion resistance over available cement based finishes available on the market today.

The composition in accordance to the principles of the present invention once applied to a surface as a coating has hydrophobic properties (water-shedding properties), which, in turn allows the coating to shed water and prevent infiltration of water pass the protective coating produced from the inventive composition. It also has increased abrasion resistance and retains the color pigment and luster of the originally applied composition for a longer period of time when exposed to atmospheric and weather conditions. That is, efflorescence of the composition when applied to the exterior of a building is unexpectedly reduced due to the increase in polymer content of the composition.

Applying the composition of the present invention will transform a porous rough construction surface, such as a traditional stucco surface or concrete, into a surface in which all the pores and crevices are filled so as to provide a smooth, impervious, weather-resistant color retention coating. Antimicrobial agents and anti-fungal agents can also be added to impart antimicrobial and anti-fungal properties to the coating as well. That is, the compositions of the present invention which can be colored, include fungicides, biocides as well as a vast array of other additives as long as the additives do not produce substantial VOC's so as to be consistent with the zero (0) VOC objective of the present invention.

One objective of the present invention is to provide a composition having the aforementioned characteristics that can be stored as a dry composition until it is ready to be used at which time the composition can be mixed with water (usually on-site) and applied to a properly prepared surface. The claimed composition can be applied to the prepared surface using the method of the present invention. One embodiment of the present invention is directed to a composition comprising about 5 to about 95% by weight of dry cement with the remainder of the composition comprising particles having a bulk density equal to or greater than about 8 pounds/gal. The particles of the composition comprising about 0.10 to about 20% by weight of at least one dry thickening agent, about 0.10 to about 95.0% by weight of a particulate having an average particle size of about 10 microns to about 3 mm; and about 0.10 to about 10.0% by weight of an antimicrobial or biocide material wherein the sum of the dry cement and said particles does not exceed 100% by weight.

In another embodiment of the present invention the composition further comprises about 1 to about 90% by weight of at least one emulsion and/or re-dispersible powder polymer having an average particle size ranging from about 0.3 to about 9 microns wherein more than about 90% by volume of said emulsion and/or re-dispersible powder polymer particles are less than or equal to about 400 μm. This particulate size is key in producing a composition that can fill in all of the gaps, cracks, crevices and pores of the surface to which it is being applied.

Another objective of the present invention is to provide a method for coating a surface with the composition of the present invention as described above comprising preparing the surface for coating with the composition and then coating the surface with the composition. In one embodiment of the present invention, the surface is prepared by applying a primer to a substantially flat continuous surface to produce a primed surface and applying the composition of the present invention to the primed surface to produce a finished surface. Preparation of the surface to be coated is dependent on the condition and the material in which the surface to be coated is constructed. Accordingly, another embodiment of the method of the present invention comprises additional preparation steps of the surface to be coated. The method of the present invention may also include adhering at least one water-resistive and drainage barrier material to a surface to produce a protected surface, fastening a wire lath to the protected surface to produce a reinforced surface that creates a substrate offering mechanical bonding characteristics. Further preparation may include applying a construction grade material such as Portland cement stucco to the wire lath so as to produce a substantially flat continuous surface. It is to this flat substantially flat surface that the composition of the present invention is applied to produce a sealed, water shedding (hydrophobic properties), and strengthened, esthetically pleasing, smooth coating topcoat. The compositions and methods of the present invention are further described below.

Another objective of the present invention is to provide a method for coating a surface with the composition of the present invention directly onto the surface. That is, a method to provide the direct application of the coating of the invention to a surface without the use of the primer. The surface that may be coated using this method may be the Base Coat component of an EIFS (Exterior Insulating and Finishing System) application.

### DETAILED DESCRIPTION OF THE INVENTION

The present invention provides a composition for use in construction that when applied to a surface provides a water repelling, strengthened, esthetically pleasing, smooth or textured coating topcoat. The composition can be applied to any prepared surface but is especially useful on surfaces that are brittle and porous and therefore suffer from cracking, insufficient water shedding (hydrophobic properties), low insulative properties and easy cracking. One such surface that suffers from many of these shortcomings is a traditional stucco surface known in the industry as three-coat or one-coat stucco.

Stucco or render is a material made of an aggregate, a portland cement binder and water. Stucco is applied wet and hardens to a very dense solid. It is used as a coating for walls and ceilings and for decoration. Stucco may be used to cover less visually appealing construction materials such as concrete, cinder block or clay brick and adobe, also known as CMU (cement masonry unit) but stucco itself is a very porous, non-smooth finish. Stucco is different than plaster and mortar. This difference is based more on use than composition. Until the later part of the nineteenth century, plaster was commonly used inside a building, while stucco was used outside. Traditional stucco consists of lime and sand (which are also used in mortar). Animal, plant or synthetic fibers were often added for additional strength. In the later part of the nineteenth century, modern stucco included Portland cement in an attempt to improve its durability. Portland cement is the most common type of cement and is a basic ingredient of concrete, mortar, as well as modern stucco.

Although modern stucco including Portland cement has increased durability over traditional stucco it is also more rigid. This rigidity produces a rough surface and compromises its ability to maintain an attractive exterior surface with the passage of time. It is well known that wall panels tend to shift during the life of the building due to settling and seasonal variations in temperature and the joints between the panels must therefore accommodate these movements. The traditional solution to this problem is to fill the joint with a caulking compound. However, both hard and soft curing caulking compounds tend to shrink or expand under these circumstances and cannot be depended upon to maintain the watertight seal they were intended to form. In addition, both types of caulk give rise to irregularities on the outer surface of the stucco coat around the joint areas such as cusps or depressions that significantly and permanently alter the outward appearance of the stucco finish. Another well-known problem is the formation upon curing of a discontinuity in appearance of the stucco coat across the face of the finished wall. This problem exhibits itself both across the face of individual wallboard panels and at the joint between juxtaposed panels. Another problem with stucco and other coatings in general, is that long-term antimicrobial protection does not exist. The present invention is designed so as to overcome this shortcoming as further described in the sections below.

Even with the many shortcomings of stucco, it is nevertheless, a very popular construction material. Although various solutions to these shortcomings have been proposed in the past, the composition of the present invention addresses many if not all of these shortcomings in a single thinly applied topcoat layer. That is, as further described below, the composition of the present invention when applied to a prepared surface using the method of the present invention produces, a sealed, water shedding (hydrophobic properties), strengthened, esthetically pleasing, uniform surface that corrects many of the shortcomings of stucco and similar coatings as discussed above. In particular, the present composition fills in the cracks and pores of the stucco surface to produce a uniform, textured appearance that seals the surface to increase its thermal retention and water-shedding or hydrophobic properties and long-term antimicrobial properties. The composition of the present invention also provides additional flexibility to the stucco or cementitious surface so reduce chipping and limit cracking due to settling of the building. Therefore, all in all the present composition remedies many if not all of the shortcomings of stucco by decreasing the cost associated with surfacing a building. This is also achieved without the potentially harmful VOC typically associated with acrylic based coatings.

The following discloses the specific components that are combined to produce the various embodiments of the dry mix composition of the present invention. Each component is identified by the generic name of the product or by a well-known trade name with the basic chemical formula (if available) for each component. The component name is used for ease and clarity of description. Although specific trade names and/or product names have been disclosed, the invention is not limited to those products, but should include any product that can be substituted for any of the recited component products.

The present invention is directed to a composition for use in construction comprising about 5 to about 95% by weight of dry cement, with the remainder of the composition comprising particles having a bulk density equal to or greater than about 8 pounds/gal. The particles of the composition comprising about 0.10 to about 95.0% by weight of a particulate having an average particle size of about 10 microns to about 3 mm. Additional embodiments of the present invention may contain about 5 to about 80% by weight of dry cement, about 15 to about 70% of dry cement, about 25 to about 65% of dry cement as well as numerous percentages in between. As with all of the embodiments of the present invention, the difference between the percentage of cement in the composition and 100% is made upon of the particles of the present invention.

The term “cement” in the context of this formulation is intended to include, but is not limited to: hydraulic, gypsum and alite cements, such as Portland Cement; blended cements; masonry cement; oil well cement; natural cement; alumina cement; expansive cements, and the like, and mixtures thereof.

It is preferred that the particles of the present composition be in the dry powdered form to allow for easy mixing with the rest of the components of the composition. Particles of the present invention may comprise about 0.10 to about 20% by weight of at least one dry thickening agent. In the alternative embodiments of the present invention the composition may contain about 1 to about 15% by weight of at least one thickening agent, about 5 to about 10% by weight of at least one thickening agent as well as numerous percentages in between. The thickening agents that may be used in the present invention include but are not limited to one or more polysaccharide plasticizers which can be further subdivided into cellulose based materials and derivatives thereof, starch based materials and derivatives thereof, and other polysaccharides. Suitable cellulose based rheology-modifying agents include, for example, methylhydroxyethylcellulose, hydroxymethylethylcellulose, carboxymethylcellulose, methylcellulose, ethylcellulose, hydroxyethylcellulose, hydroxyethylpropylcellulose, etc. The entire range of possible permutations is enormous and for practical purposes need not be listed. Nevertheless, it will be appreciated that many other cellulose materials have essentially the same or similar properties as those mentioned and are equivalent for the present purposes. Suitable starch based materials include, for example, amylopectin, amylose, sea-gel, starch acetates, starch hydroxyethyl ethers, ionic starches, long-chain alkylstarches, dextrins, amine starches, phosphate starches, and dialdehyde starches. Other natural polysaccharide based rheology-modifying agents include, for example, alginic acid, phycocolloids, agar, gum arabic, guar gum, welan gum, locust bean gum, gum karaya, and gum tragacanth, cellulose ether, modified cellulose ether, polyvinyl alcohol acetylated hydrophobically modified polyvinyl alcohol, and mixtures thereof. It is preferred that thickening agents used in the present invention be limited to non-VOC producing thickening agents upon re-hydration of the composition of the present invention with water. One specific thickening agent that can be used is Bermocoll E 411 FQ available from AkzoNobel.

The present composition may also contain about 0.10 to about 95.0% by weight of a particulate having an average particle size of about 10 microns to about 3 mm. In alternative embodiments of the present invention the composition may contain about 1 to about 80% by weight of at least one particulate, about 5 to about 65% by weight of at least one particulate, 20 to about 50% of at least one particulate as well as numerous percentages in between and mixtures thereof. The term “particulate” in the context of this formulation is intended to include, but is not limited to any type of course ground non-reactive particle including sand that is commonly used in the building industry, ground fiberglass, small beads glass beads, ground plastic, and mixtures thereof. Examples of suitable sands include ASTM 20/30 silica sands, dune sands, beach sands and job site sands.

The composition of the present invention may also contain about 0.10 to about 10.0% by weight of an antimicrobial and/or biocide material. In alternative embodiments of the present invention the composition may contain about 1 to about 6% by weight of an antimicrobial and/or biocide material, about 2 to about 4% by weight of an antimicrobial and/or biocide material, as well as numerous percentages in between. The terms “antimicrobial” and/or “biocide” in the context of this formulation is intended to include, but is not limited to fungicides, herbicides, insecticides, antimicrobial agents comprising sodium, potassium, calcium, zinc, copper, and barium salts of carbonate, silicate, sulfate, halide, and borate in all forms; zinc carboxylates; boric acids; sodium dichromate; copper chrome arsenate (CCA); chromated copper borate (CBC); ammoniacal copper arsenate (ACA); ammoniacal copper zinc arsenate (ACZA); copper chromium fluoride (CFK); copper chromium fluoroborate (CCFB); copper chromium phosphorous (CCP); propiconazole tebuconazole; organo-chloride such as pentachlorophenol (PCP); quaternary ammonium compounds (AAC); copper 8-hydroxyquinoline or copper oxene; tri-n-butyltin oxide (TBTO); tri-n-butyltin naphthenate (TBTN); didecyldimethylammonium bromide (DDAB); didecyldimethylammonium chloride (DDAC); silver ions, mercury ions, carbamates, isothiazolones, chlorinated phenoxy and polyhexamethylene beguanidide hydrochlorides, barium metaborate monohydrate, borate salts and mixtures thereof. Preferred compositions of the present invention are water insoluble and comprise inorganic biocides.

In another embodiment of the present invention the composition of the present invention may further comprise about 1 to about 90% by weight of at least one emulsion and/or re-dispersible powder polymer having an average particle size ranging from about 0.3 to about 9 microns wherein more than about 90% by volume of said re-dispersible powder particles are less than or equal to about 400 μm. The terms “re-dispersible polymer powder” and “emulsion polymer” in the context of this formulation are intended to include, but are not limited to acrylic, SBR, silicons, polyurethane dispersions, polyurethane, alkyl carboxylic acid vinyl ester monomers, branched and unbranched alcohol (meth)acrylic acid ester monomers, vinyl aromatic monomers, olefin monomers, diene monomers and vinyl halide monomers, vinyl ethylene ester and ethylene, vinyl laurate vinyl chloride copolymers, vinyl ester monomers, (meth)acrylate monomers, vinyl aromatic monomers, olefin monomers, 1,3-diene monomers, vinyl halide monomers, homopolymers or copolymers derived from one or more monomers selected from the group consisting of vinyl acetate, vinyl esters of .alpha.-branched monocarboxylic acids having from 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, and styrene. and hydrophobic re-dispersible polymer powders compatible with cement binders.

In yet another embodiment of the present invention, the composition may further comprise about 0.1 to about 10% by weight of at least one plasticizer and/or super-plasticizer. The terms “plasticizer and/or superplasticizer” in the context of this formulation is intended to include, but is not limited to polymerized melamine sulfonate, lignin sulfonates, polycarboxylates, poly(meth)acrylates. One plasticizer and/or superplasticizer that can be used in the present composition is Melment F10 available from Degussa Chemical Company.

In yet still another embodiment of the present invention the composition of the present invention may further comprises about 0.1 to about 20% by weight of pozzolans. The term “pozzolans” in the context of this formulation is intended to include, but is not limited to fly ash, slag, diatomaceous earth, silica fume, calcined shale, metakaolin, rice husk ash, natural pozzolans, and mixtures thereof. The term “fly ash” generally refers to a solid powder having a chemical composition similar to or substantially the same as the composition of the material that is produced during the combustion of powdered coal. This material typically comprises from 25% to about 60% silica, from 10% to about 30% AL.sub.2O.sub.3, from 5% to about 25% Fe.sub.20.sub.3, from 0% to about 20% CaO, and from 0% to about 5% MgO. Fly ash particles are typically spherical, ranging in diameter from 1 to 45 microns. In the cementitious composition, the proportion of fly ash comprising particles of less than 45 microns and greater than 10 microns in size is preferably between 5% and around 4% more preferably between 10% and around 35%, and most preferably between 15% and around 30% by weight, based on the total dry ingredients. The proportion of fly ash comprising particles of less than 110 microns in size in the composition is preferably between 1% and around 25%, more preferably between 5% and around 20% and most preferably between 10% and around 15% by weight, based on the total dry ingredients. Class F fly ash greatly reduces the risk of expansion due to sulfate attack.

In another embodiment, a mixture of the re-dispersible polymer powders and emulsion polymers described above can be prepared without the cementious ingredient, which can be added at a later time. For example, one embodiment of the this mixture comprises about 1 to about 90% by weight of at least one emulsion and/or re-dispersible powder polymer having an average particle size ranging from about 0.3 to about 9 microns wherein more than about 90% by volume of said re-dispersible powder particles are less than or equal to about 400 μm. The re-dispersible polymer powder and emulsion polymer can be selected from the group consisting essentially of acrylic, SBR, silicons, polyurethane dispersions, polyurethane, alkyl carboxylic acid vinyl ester monomers, branched and unbranched alcohol (meth)acrylic acid ester monomers, vinyl aromatic monomers, olefin monomers, diene monomers and vinyl halide monomers, vinyl ethylene ester and ethylene, vinyl laurate vinyl chloride copolymers, vinyl ester monomers, (meth)acrylate monomers, vinyl aromatic monomers, olefin 1monomers, 1,3-diene monomers, vinyl halide monomers, homopolymers or copolymers derived from one or more monomers selected from the group consisting of vinyl acetate, vinyl esters of .alpha.-branched monocarboxylic acids having from 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethyihexyl acrylate, styrene, hydrophobic re-dispersible polymer powders compatible with cement binders and mixtures thereof. This mixture can be prepackaged with instructions for mixing with the re-dispersible polymer powders and emulsion polymers mixture with the proper type and amount of cement on site. Once mixed, water can be added and the product applied as described below. Shipping the re-dispersible polymer powder and emulsion polymer mixture without the added cement is lower but it is essential that the mixture of these ingredients with cement be precise in order to obtain the benefits of the coating. Therefore, the complete mixture including the cement is preferred so that the proper ratios of ingredients are assured when mixed under controlled conditions in the factory instead on a job site. Other pre-mixes can be made according to the disclosure described herein.

Other embodiments of the composition of the present invention may include in addition to the various components discussed above about 0.5% to about 10% by weight of expansion additives, about 10% by weight of one or more additives selected from the group consisting of flame retardants, pigments, dyes, colorants, stabilizers, ultraviolet light absorbers, antioxidants, insect repellants and mixtures thereof. Pigments that can be used include, without limitation, inorganic pigments such as carbon black, graphite, expandable graphite, zinc oxide, titanium dioxide, and iron oxide, organic pigments, such as quinacridone reds, violets, copper phthalocyanine blues, greens and mixtures thereof.

The present invention is also directed to a method for coating a surface with a least one of the compositions of the present invention described above. The method of the present invention comprises preparing a surface to be coated with at least one of the compositions of the present invention and coating the prepared surface with the composition. The coating can be applied to the prepared surface by trowel, Spackle knife, brush, spray or hopper gun, or any other application device commonly used in the plastering, masonry or painting trades.

The preparation of the surface to be coated depends on materials in which the surface is constructed, the condition of the surface prior to preparation, and the location of the surface to be coated (either inside or outside of the building). If the surface is in relatively good condition or has been recently coated with traditional or modern stucco preparation of the surface for coating comprises applying a primer to the substantially flat continuous surface to produce a primed surface. Then, at least one of the compositions of the present invention can be applied to the prepared surface to produce a finished surface.

The surface must be free of laitance and free of contaminants. The primer must be rolled over the cementitious substrate at a rate of about 200 square feet per gallon, plus or minus 10% depending upon substrate porosity. The primer is prepared by adding about 1½ gallons of water to 20 lbs of the primer and is mixed with, for example a paddle until a substantially uniform consistency is achieved.

In the event that the surface needs to be coated with a masonry mixture, such as stucco or a stucco-like material prior to applying at least one of the compositions of the present invention, the preparation of the surface may include all or part of the following procedures. Affixing at least one water-resistive and drainage barrier material to a surface to produce a protected surface; fastening a wire lath to the protected surface to produce a reinforced surface providing mechanical bond for the stucco to adhere thereto; and applying a construction grade material, such as One Coat Stucco, to said wire lath to produce said substantially flat continuous surface. The wire lath may be constructed from 20 gauge galvanized steel having a diamond pattern, or any other gauge and type of metal, plastic, man-made material used to prepare surfaces for a masonry material. The material applied to the lath can be selected from the group consisting of a cement containing material, traditional or modern stucco, plaster, mortar, or any other material used in the masonry trade; These materials can be applied in a thickness of about ⅜—to about 1 inch thick in order to prepare the surface for application of at least one composition of the present invention.

The composition of the present invention can be applied to prepared surface in a thickness of up to about 3 mm, preferable about 1.5 mm of an inch and more preferable about 1 mm. The thickness in which the composition is applied depends on the surface being coated as well as the purpose for the coating i.e. esthetic only, and/or water-shedding (hydrophobic properties) and/or increased strength. In order to assure maximum waterproofing, prior to and/or after application of the composition of the present invention a sealant material can be applied to joints, turns, around windows and/or door jams as well as pipes and vents so as provide sealant properties to said joints.

As with many masonry products, a skilled tradesman is recommended but a mechanically equipped non-tradesman may also be able to apply the compositions of the present invention using the methods of the present invention. The following example is provided to demonstrate the characteristics, attributes and unexpected results of one embodiment of the present invention and is not offered so as to be limiting on the present invention.

All in all, the composition of the present invention has many favorable characteristics over traditional Stucco and/or Exterior Insulation and Finishing System (EIFS). A chart comparing the characteristics of traditional Stucco, EIFS and the composition of the present invention is provided below. As can bee seen from this chart not only does the product of the present invention not produce VOCs, which makes it less hazardous for the worker, user and environment, but it also possesses many more favorable characteristics than these two popular surfaces.

| PERFORMANCE | COMPOSITION OF THE | | TRADITIONAL |
|---|---|---|---|
| PROPERTY | PRESENT INVENTION | EIFS | STUCCO |
| Green Technology | Exceeds Industry Standard | Below Industry Standard | Exceeds Industry Standard |
| Green Packaging | Exceeds Industry Standard | Below Industry Standard | Exceeds Industry Standard |
| Flame and Smoke | Exceeds Industry Standard | Below Industry Standard | Exceeds Industry Standard |
| Resistance | | | |
| Impact Resistance | Exceeds Industry Standard | Below Industry Standard | Exceeds Industry Standard |
| UV Degradation | Exceeds Industry Standard | Below Industry Standard | Exceeds Industry Standard |
| Yellowing | | | |
| Longevity | Exceeds Industry Standard | Unstable | Exceeds Industry Standard |
| Dirt Pickup Resistance | Exceeds Industry Standard | Costly—extra | Below Industry Standard |
| Elastomeric | Exceeds Industry Standard | Costly—extra | Below Industry Standard |
| Anti-Microbial | Exceeds Industry Standard | Costly—extra | Below Industry Standard |
| Protection | | | |
| Crack Resistance | Exceeds Industry Standard | Exceeds Industry | Below Industry Standard |
| | | Standard | |
| Ease of Spread | Exceeds Industry Standard | Exceeds Industry | Below Industry Standard |
| | | Standard | |
| No Misting Required | Exceeds Industry Standard | Exceeds Industry | Below Industry Standard |
| | | Standard | |
| Color Tinting on Site | Exceeds Industry Standard | Exceeds Industry | Below Industry Standard |
| | | Standard | |
| Real vs. Synthetic | Exceeds Industry Standard | Below Industry Standard | Exceeds Industry Standard |
| Appearance | | | |
| Wastage/Droppage | Exceeds Industry Standard | Below Industry Standard | Below Industry Standard |
| Extended Winter | Exceeds Industry Standard | Below Industry Standard | Below Industry Standard |
| Application | | | |
| Yield per Unit | Exceeds Industry Standard | Below Industry Standard | Below Industry Standard |
| Low Freight Cost | Exceeds Industry Standard | Below Industry Standard | Below Industry Standard |
| Lowest Installed Cost | Exceptional | Below Industry Standard | Below Industry Standard |

### EXAMPLES

Test Methodology

Three Test panels were constructed using an Exterior Insulating Finishing Systems (EIFS) configuration. Each of the panels were prepared with EPS foam, mesh and base coat. Once the panels were prepared, a coating was prepared and placed on the surface in accordance with the principles of the present disclosure. The coating according to the present disclosure had a sand finish and a color of Burnished Lime.

The coating composition applied to panels 1 and 2 were the same where the composition applied to panel 3 had about a 30% polymer increase. All other ingredients of the composition applied to panels 1 and 2 compared to panel 3 remained the same except for the increase in polymer material and a decrease in water. Water was added to each composition just prior to application in accordance with the principles of the present disclosure. A full list of the dry materials in each of the two compositions is provided in Table 1 with the remainder weight percent being water.

It is envisioned that the composition of the present disclosure can have other ingredients including pigments, preservatives, biocides, ant-caking materials, anti-moisture materials for storage as long as the addition of the added ingredients does not reduce the polymer content of the resulting composition below 30% by weight.

When a water insoluble biocide is added to the composition of the present disclosure, it is noted that because of the water insoluble nature of the biocide it cannot be extracted from the coating composition by outdoor exposure. Such biocide being inorganic in nature prevents molecular degradation upon exposure to the UV rays from the sun.

The coating composition has a density of about 12 lbs per gallon (differentiating from light weight compositions of much lower densities) and can be applied at thicknesses ranging from 1 to 2 mils up to about 60 mils (differentiating from thick plastering such as stucco that are typically applied at thicknesses in excess of 125 mils). The composition of matter described in this invention consists o hydraulic cement and a polymer in the form of emulsion or redispersible powder as the main ingredients along with additional additives as described in this disclosure. One redispersible powder that can be used in the present invention is Vinnapas 8031H available from Wacker Chemical Corporation.

The fundamentally inorganic nature of this coating composition prevents any significant deterioration to take place upon outdoor exposure. From the data generated below it has been found unexpectedly that an increase in the polymer content of more than 30% drastically reduces the efflorescence of the composition of the present disclosure. The results of the testing are presented in the table directly below.

It is noted although there is an increase in polymer material in composition 2 applied to panel 3 there was no change in the color of each mixture when applied to the respective panel.

TABLE 1

| | Pts by Wt (Panels #1 | Pts by Wt (Panel #3 |
|---|---|---|
| Ingredients | and #2 Formulation) | Formulation) |
| White Cement | 100.00 | 100.00 |
| Wacker 8031H* | 17.47 | 22.71 |
| Wacker 5028N* | 17.47 | 22.71 |
| Gypsum | 3.43 | 3.43 |
| Silica Fume | 2.94 | 2.94 |
| Melment F-10* | 0.55 | 0.55 |
| Sodium Gluconate | 0.07 | 0.07 |
| MKS 10,000 PF-60 | 1.27 | 1.27 |
| Silco-sil#75 | 93.00 | 93.00 |
| Tio2 pigment | 14.00 | 14.00 |
| ERA 200 | 2.87 | 2.87 |
| Busan 11M1* | 1.96 | 1.96 |
| GS 20 Sand | 519.00 | 519.00 |
| GS40 Sand | 214.00 | 214.00 |
| TOTAL | 988.03 | 998.51 |

*8031H is a hydrophobic polymer, a copolymer of vinyl chloride, ethylene and vinyl ester used as a thickening agent available from Wacker Chemical Company.
*5028 is a film forming vinyl acetate ethylene copolymer available from Wacker Chemical Corporation.
*Melment F-10 is a plasticizer/super plasticizer available from Degussa Chemical Company.
*Busan 11M1 is a Bactericide available from Buckman Laboratories.

Once composition 1 was applied to panels 1 and 2 and comparative composition was added to panel 3 according to the method of the present disclosure, all three panels were cured for 48 hours at room temperature. Once dried for 48 hours Panel #1 was kept as a control indoors at the laboratory. Panels #2 and #3 were placed outdoors and were exposed to sun, dew, rain, wind and atmospheric conditions for three consecutive days. At the end of the three-day period, Panels #2 and #3 were dried and taken to the lab for color analysis. Color analysis of panels 1, 2 and 3 was conducted using a spectrophotometer. Color comparisons were made with the unexposed control Panel #1. The spectrophotometer used was Color Eye XTH from X-Rite Corp. The color program used was Color I-Match, available from X-Rite Corporation, 4300 44^{th} St. SE, Grand Rapids, Mich. 49512, 800-248-9748; Color i match, version 5.4 Color Formulation Software. Below is a discussion of the results.

### Results and Discussions

Efflorescence changes (color changes) in cement compositions appear as a white stain or film that changes the original color of the coating composition once the coating is applied and dried. Sometimes the change is very noticeable. As stated above, the color change in the applied finish was determined by Spectrometer after the coating was applied and exposed to weather for 3-days.

The color change in the TESS finish caused by the 3-day rain exposure of Panels #2 and #3 were determined by spectrophotometer comparisons with a control sample labeled Panel #1. Color comparisons to the Panel #1 were measured by the determined value “Delta E,” as reported by the spectrophotometer. The lightness or brightness of the color is reported by the “L” value. Any whitening of the color in the TESS finish caused by efflorescence as a result of rain exposure would show up in the Delta E and L values when compared to the control samples. Delta E values under 1.0 are considered close color matches, while Delta E values around 0.5 and under are considered very close color matches. The same applies for the L values in color comparisons. The determined values of Delta e and L values are provided below.

### Spectrophotometer Results

| Value | Delta E | L |
|---|---|---|
| Panel #2 | 1.35 | 0.8 |
| Original Formulation | | |
| Panel #3 | 0.46 | −.01 |
| Formulation with 30% | | |
| Polymer increase | | |

The affects of adding a TESS primer prior to adding the efflorescence resistant TESS finish was also studied. Similarly the effects of weather on a TESS finish that was applied over a TESS primer, particularly with regards to efflorescence was determined over a year period. In the study 2 building coated with a TESS primer prior to applying the TESS finish was studied over a one-year period. The results were then recorded by visual inspection since the differences between the two buildings was so apparent spectrophotometer was not necessary. Both buildings were located in Queens, N.Y. and were subjected to the same amount of daylight, sunlight, weather conditions and amount of pollution, all of which can affect the amount of efflorescence of the TESS finish, over the one period.

Building #1

The Super-Tek building located in Queens, N.Y. was coated with the TESS finish using the TESS primer at least one year ago. A visual inspection of the color retention of the building was taken and was determined to be pretty good. That is, the color retention as compared to the original color was overall pretty good meaning that more than 80% of the original color has been maintained.

Building #2

The ABC Corp building located in Queens, N.Y. was also coated with the TESS finish, but no primer was used. A visual inspection of the color retention of the building was taken and was determined to be very poor. That is, the color retention as compared to the original color was very poor meaning that less than 50% of the original color has been maintained. Closer visual and chemical examination of the surface indicated that the whitening effect was the result of efflorescence.

### Results

Comparison of building #1 compared to building # 2 indicated that building #1 with the TESS primer applied priori to applying the TESS coating had more than 30% more color retention after the experimental period than building #2. That is, due to increased efflorescence resistance, building #2 having the TESS finish without the primer was duller and less vibrant than building #1.

### Overall Results

As can be seen from the spectrophotometer results, Panel #3 was essentially unaffected by the rain exposure when compared to the control panel #1. As stated above, panel #3 having the improved TESS finish described in the present disclosure This is considered a breakthrough in cement technology since all cement based compositions available on the market are affected by rain especially after a short cure time of only 48 hrs. This data is extremely important and totally unexpected.

In addition, applying the TESS primer prior to applying the improved TESS composition of the present disclosure is very important in reducing efflorescence in the TESS finish thereby increasing color retention of the coating. Using the TESS primer before the application of the TESS composition in accordance with the principles of the present disclosure prevents efflorescence by in climate weather over time.

The data presented above demonstrates that the compositions described herein raise the state of the art in efflorescence protections of coatings in that the effectiveness of the composition due to the additional polymer content as compared to earlier versions of the TESS composition provides for increased protection against loss of color and luster of the finish when applied in accordance with the procedures of the present disclosure over time due to weather conditions. The composition of the present invention also provides a finish that has increased abrasion resistance as compared to compositions having less polymer content. In addition, applying a primer according to the principles of the present disclosure increases the effectiveness of the TESS coating against efflorescence and therefore leads to higher color retention.

The compositions and methods of the present disclosure can be used and include all types of exterior and interior coatings including EIFS (exterior insulating finishing systems), One Coat Stucco Systems or other cladding systems. The present invention is also directed to coated articles that include structural, construction and ornamental articles coated with the composition of present disclosure.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A composition for use in construction having enhanced color retention and abrasion resistance comprising:
at least one pigment, dye, or colorant material;
about 10 to about 20% by weight of dry cement with the remainder of the composition comprising particles having a bulk density greater than about 8 pounds/gal;
said particles comprising about 0.10 to about 20% by weight of at least one dry thickening agent;
about 0.10 to about 95.0% by weight of a particulate having an average particle size of about 10 microns to about 3 mm; and
about 4.0 to about 10% by weight of at least one emulsion and/or redispersible powder polymer having an average particle size ranging from about 0.3 to about 9 microns wherein more than about 90% by volume of said re-dispersible powder particles are less than or equal to about 400 μm; and
wherein the composition contains at least 30% by weight of the powder polymer so as to reduce the efflorescence of the composition.

2. A composition of claim 1 wherein said particles further comprises
about 0.10 to about 10.0% by weight of an antimicrobial and/or biocide material wherein the sum of said dry cement and said particles does not exceed 100% by weight.

3. A composition of claim 2 wherein said particles further comprises about 0.1 to about 10% by weight of at least one plasticizer and/or super-plasticizer.

4. A composition of claim 3 further comprising about 0.1 to about 20% by weight of pozzolans.

5. A composition of claim 4 wherein said particles further comprises about 0.5% to about 10% by weight of expansion additives.

6. A composition of claim 5 wherein said particles further comprises about 10% by weight of one or more additives selected from the group consisting of flame retardants, stabilizers, ultraviolet light absorbers, antioxidants, insect repellants and mixtures thereof.

7. A composition of claim 1 wherein said pigment includes, without limitation, inorganic pigments such as carbon black, graphite, expandable graphite, zinc oxide, titanium dioxide, and iron oxide, organic pigments, such as quinacridone reds, violets, copper phthalocyanine blues, greens and mixtures thereof.

8. A composition of claim 1 wherein said one or more thickening agent is selected from the group consisting of cellulose ether, modified cellulose ether, a non-toxic water soluble cellulose ether, ethyl hydroxyethyl cellulose, polyvinyl alcohol acetylated hydrophobically modified polyvinyl alcohol and mixtures thereof.

9. A composition of claim 1 wherein said antimicrobial or biocide material is selected from the group consisting of fungicides, herbicides, insecticides, antimicrobial agents can include sodium, potassium, calcium, zinc, copper, and barium salts of carbonate, silicate, sulfate, halide, and borate in all forms; zinc carboxylates; boric acids; sodium dichromate; copper chrome arsenate (CCA); chromated copper borate (CBC); ammoniacal copper arsenate (ACA); ammoniacal copper zinc arsenate (ACZA); copper chromium fluoride (CFK); copper chromium fluoroborate (CCFB); copper chromium phosphorous (CCP); propiconazole tebuconazole; organo-chloride, pentachlorophenol (PCP); quaternary ammonium compounds (AAC); copper 8-hydroxyquinoline or copper oxene; tri-n-butyltin oxide (TBTO); tri-n-butyltin naphthenate (TBTN); didecyldimethylammonium bromide (DDAB); didecyldimethylammonium chloride (DDAC); silver ions, mercury ions, carbamates, isothiazolones, chlorinated phenoxy and polyhexamethylene beguanidide hydrochlorides, barium metaborate monohydrate, borate salts and mixtures thereof.

10. A composition of claim 2 wherein said one or more redispersible powder polymers is selected from the group consisting of hydrophobic polymer, acrylics, silicons, polyurethane dispersions, polyurethane, alkyl carboxylic acid vinyl ester monomers, branched and unbranched alcohol (meth) acrylic acid ester monomers, vinyl aromatic monomers, olefin monomers, diene monomers and vinyl halide monomers, a copolymer of vinyl chloride, ethylene, vinyl ester, vinyl and acetate ethylene copolymer.

11. A composition of claim 10 wherein said emulsion can be an acrylic or SBR and at least one re-dispersible powder polymer, copolymer or terpolymer is selected from the group consisting of vinyl ethylene ester and ethylene, vinyl laurate vinyl chloride copolymers, vinyl ester monomers, (meth)acrylate monomers, vinyl aromatic monomers, olefin monomers, 1,3-diene monomers, vinyl halide monomers, homopolymers or copolymers derived from one or more monomers selected from the group consisting of vinyl acetate, vinyl esters of .alpha.-branched monocarboxylic acids having from 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, and styrene and hydrophobic re-dispersible polymer powders compatible with cement binders.

12. A composition of claim 3 wherein said plasticizer and/or superplasticizer is selected from the group consisting of polymerized melamine sulfonate, lignin sulfonates, polycarboxylates, poly(methly acrylates.

13. A composition of claim 3 wherein said one or more pozzolans is selected from the group consisting of class C fly ash, class F fly ash, slag, diatomaceous earth, silica fume, calcined shale, metakaolin, rice husk ash, natural pozzolans, and mixtures thereof.

14. A method for coating a surface with a composition of claim 1 comprising preparing said surface for coating with said composition; and
coating said surface with said composition.

15. A method of claim 14 wherein preparing said surface for coating comprises applying a primer to a substantially flat continuous surface that is substantially free of laitance and contaminates to produce a primed surface; and
applying said composition to said primed surface to produce a finished surface.

16. A method of claim 15 wherein said substantially flat continuous surface is produced by adhering at least one water-resistive and drainage barrier material to a surface to produce a protected surface;
fastening a wire lath to said protected surface to produce a reinforced, mechanically bondable surface; and
applying a construction grade material to said wire lath to produce said substantially flat continuous surface.

17. A method of claim 16 wherein the wire lath is made from 20 gauge galvanized steel having a diamond pattern.

18. A method of claim 15 where in said primer is applied to the substantially flat surface by roller at a rate of about 200 square feet per gallon.

19. A method of claim 18 wherein the primer is prepared by adding about 1½ gallons of water to about 20 lbs of the primer which is then mixed with until a substantially uniform consistency is achieved.

20. An exterior building surface coated with the composition of claim 1.

21. A composition of claim 2 wherein a plasticizer and/or super-plasticizer is a spray dried sulfonated polycondensation product based on melamine.

22. A composition of claim 4 wherein the pozzolans is fly ash.

23. A composition of claim 4 wherein a expansion additive is a sulfate mineral composed of calcium sulfate dihydrate having the chemical formual CaSO4.2H2O.
